(19) United States
(12) Patent Application Publication
(10) Pub. No.: US 2002/0054151 A1
(43) Pub. Date: May 9, 2002

(54) Information processing method and apparatus and medium

(76) Inventors: Shoji Inomata, Kanagawa (JP); Hiromitsu Baba, Kanagawa (JP); Kayo Ishii, Tokyo (JP); Kaori Kashimoto, Kanagawa (JP)

Correspondence Address: FROMMER LAWRENCE & HAUG LLP, 745 FIFTH AVENUE, NEW YORK, NY, 10151, US

(21) Appl. No.: 09/864,970

(22) Filed: May 24, 2001

(30) Foreign Application Priority Data
May 25, 2000 (JP) 2000-155402

(51) Int. Cl. G09G 5/00

(52) U.S. Cl. 345/810

(57) ABSTRACT

An information processing apparatus having a jog dial in which plural operation possibilities can be allocated to one operation of a jog dial to enlarge the range of operation in case of employing the jog dial to permit a user to recognize instantly that the apparatus is in the jog dial operating mode. On detection of one-click rotation of the jog dial by one click at step S2 and on detection of the pushing of the jog dial at step S3, the operating mode is switched to an operating mode in meeting with the operation on the jog dial. On detection of rotation by one click of the jog dial at step S2, an item list of an application software installed is displayed (launcher display) at step S7. On detection of pushing of the jog dial at step S3, the category classification of the application software installed is displayed at step S4.

### BACKGROUND OF THE INVENTION

1. Field of the Invention

This invention relates to an information processing apparatus having a jog dial, an information processing method by an apparatus having a jog dial and a medium for permitting the information processing apparatus having a jog dial to execute a program.

2. Description of Related Art

Recently, a personal computer, a variety of electronic equipment or a portable information processing apparatus, such as a palm top computer, provided with a jog dial with a view to improving its operating feeling, have made their debut.

In the information processing apparatus, provided with the jog dial, the rotating operations or the pressing operations of a dial portion of the jog dial is detected to execute the processing corresponding to these operations.

Meanwhile, there are only a limited number of jog dial operations, such as an operation of thrusting a dial portion, referred to below as a push operation, an operation of rotating the dial portion, referred to below as a rotating operation, or an operation of pushing and rotating the jog dial simultaneously, referred to below as the pushing rotating operation. In the conventional information processing apparatus, each one function is allocated to one of these jog dial operations. So, with the conventional information processing apparatus, limitations are imposed on the operations that can be executed with the jog dial.

Moreover, in the conventional information processing apparatus provided with the jog dial, there is no distinction between the mode performing various processing operations responsive to the jog dial operations, and other modes, these two sorts of operations apparently existing together. So, there are occasions where the user cannot realize which is the prevailing operating mode of the information processing apparatus, and thus the user actuates the jog dial even though the prevailing mode is not the jog dial operation accommodating mode.

### SUMMARY OF THE INVENTION

It is therefore an object of the present invention to provide an information processing method and apparatus, and a medium, in which plural operation possibilities are allocated to one jog dial operation to enhance the operational range, and in which the user may instantly recognize that the apparatus is in the jog dial operation accommodating mode.

In one aspect, the present invention provides an information processing apparatus having an operator for generating a signal responsive to at least rotation and pressing thereof, in which the apparatus includes storage means for storing a plurality of icons classified in a relevant category from at least two categories, and control means for switching between a first operating mode displaying a list of the plural icons and a second operating mode for displaying only icons classified in a pre-set one of the plural categories responsive to an operation on the operator.

In another aspect, the present invention provides an information processing apparatus having an operator for generating a signal responsive to at least rotation and pressing thereof, in which the apparatus includes storage means for storing a plurality of files classified in a relevant category among at least two categories set for a pre-set application, and control means for switching between a first operating mode displaying a list of the plural files and a second operating mode for displaying only files classified in a pre-set one of the plural categories responsive to an operation on the operator.

In still another aspect, the present invention provides an information processing method for executing information processing responsive to an operating signal generated by an operator responsive to at least rotation and pressing thereof, comprising, in which the method includes a storage function of storing a plurality of icons classified in a relevant category from at least two categories, and a control function of switching between a first operating mode displaying a list of the plural icons and a second operating mode for displaying only icons classified in a pre-set one of the plural categories responsive to an operation on the operator.

In still another aspect, the present invention provides an information processing method for performing information processing responsive to an operating signal generated by an operator responsive to at least rotation and pressing thereof, in which the method includes a storage function for storing a plurality of files classified in a relevant category among at least two categories set for a pre-set application, and a control function for switching between a first operating mode displaying a list of the plural files and a second operating mode for displaying only files classified in a pre-set one of the plural categories responsive to an operation on the operator.

In still another aspect, the present invention provides a storage medium for storing a program for executing information processing responsive to an operating signal generated by an operator responsive to at least rotation and pressing thereof, in which the program includes a control processing step for switching between a first operating mode displaying a list of the plural files and a second operating mode for displaying only folders classified in a pre-set one of the plural categories responsive to an operation on the operator.

In yet another aspect, the present invention provides a storage medium for storing a program for executing information processing responsive to an operating signal generated by an operator responsive to at least rotation and pressing thereof, in which the program includes a control processing step for switching between a first operating mode displaying a list of the plural files classified in a relevant category among said categories and a second operating mode for displaying only files classified in a pre-set one of the plural categories responsive to an operation on the operator.

According to the present invention, if, in an operating mode other than an operating mode in meeting with the operation on an operator generating a signal responsive to at least rotation and pressing, it is detected that the operator has started its operation, the operating mode of the information processing apparatus is switched to an operating mode in meeting with the operation on the operator, in order to enable plural operation possibilities to be allocated to one operation on the operator to enlarge the range of operation employing the operator, and in order to enable the user to recognize instantly that the apparatus is in the operating mode in meeting with the operation on the operator.

### BRIEF DESCRIPTION OF THE DRAWINGS

FIG. 1 is a front view showing an appearance of an information processing apparatus embodying the present invention.

FIG. 2 is a bottom view showing an appearance of an information processing apparatus embodying the present invention.

FIG. 3 is a left side view showing an appearance of the information processing apparatus embodying the present invention.

FIG. 4 is a top plan view showing an appearance of the information processing apparatus embodying the present invention.

FIG. 5 is a perspective view showing a jog dial.

FIG. 6 is a perspective view showing a contact mounting substrate as an essential portion of the jog dial.

FIG. 7 is a front cross-sectional view of the jog dial.

FIG. 8 is a side cross-sectional view of the jog dial.

FIG. 9 is a side view of an equipment in use, showing the mounting state of the jog dial on the equipment in use.

FIG. 10 is a top plan view of a rotary encoder constituting a jog dial, with a portion thereof being broken away.

FIG. 11 is a top plan view for illustrating a push switch portion of the jog dial.

FIG. 12 is a block circuit diagram showing the inner circuit structure of the information processing apparatus embodying the present invention.

FIG. 13 is a front view showing an external memory medium.

FIG. 14 is a backside view of an external memory medium.

FIG. 15 is a right side view of the external memory medium.

FIG. 16 is a flowchart showing the processing flow of a CPU prior to starting of a specified application software.

FIG. 17 illustrates a typical start picture.

FIG. 18 illustrates display transition on the application category basis.

FIG. 19 illustrates display transition to an application item list.

FIG. 20 illustrates inversion display transition of menu items of the application item list.

FIG. 21 illustrates typical selection display and post-selection display of menu items of the application item list.

FIG. 22 is a flowchart showing the processing flow of the CPU after startup of the application software.

FIG. 23 illustrates a typical application start picture.

FIG. 24 illustrates the display transition on the information category basis.

FIG. 25 illustrates display transition on an information item list.

FIG. 26 illustrates inversion display transition of list items on the information item list.

FIG. 27 illustrates a typical display transition responsive to the jog dial operation following application booting.

FIG. 28 illustrates another typical display transition responsive to the jog dial operation following application booting.

FIG. 29 illustrates another typical display transition responsive to the jog dial operation following application booting.

### DESCRIPTION OF THE PREFERRED EMBODIMENTS

Referring to the drawings, preferred embodiments of the present invention will be explained in detail.

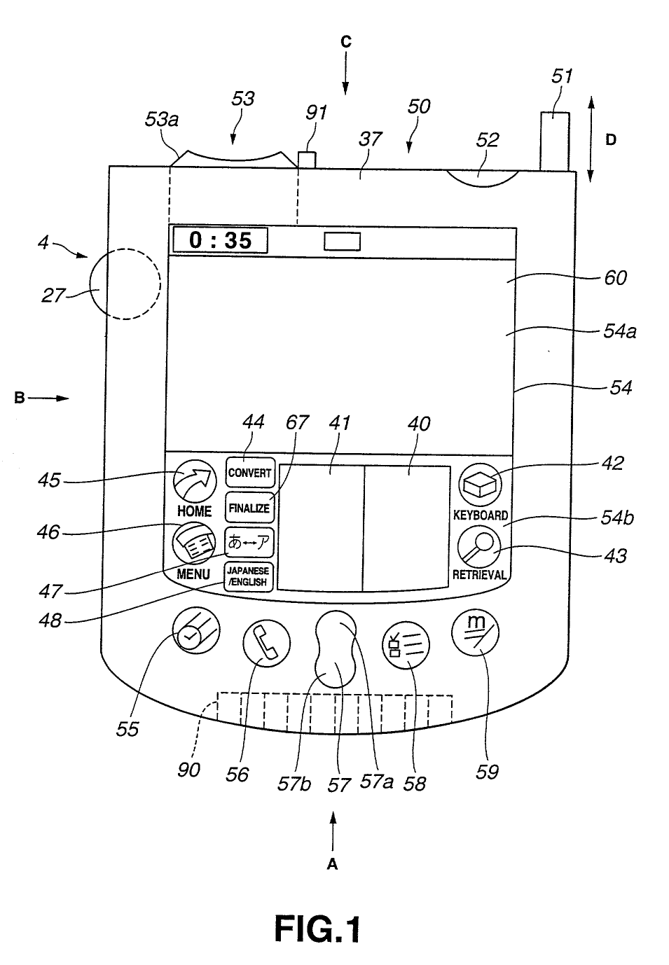

FIG. 1 schematically shows the appearance of an information processing apparatus embodying the present invention. Although FIG. 1 shows a so-called palm top computer as an example, the present invention can, of course, be applied to a variety of information processing apparatus, such as a personal computer or other portable information terminals, such as portable telephone set. Also, for explanation sake, an outer casing 37, a variety of keys 55 to 59, icons or display screens used in the present embodiment are those of a portable information terminal manufactured by Palm Inc. However, the present invention is not limited to this particular configuration.

In FIG. 1, the information processing apparatus 50 of the present embodiment is a portable computer (so-called palm top computer) that can be carried about by a user, and includes e.g., a liquid crystal display panel 60, a touch panel 54 and a variety of keys 55 to 59, mounted on an outer casing 37. The liquid crystal display panel 60 is arranged on a portion of the apparatus which proves the front side thereof when the outer casing 37 is held by hand. The touch panel 54 is arranged e.g., on the front surface of the liquid crystal display panel 60, whilst the keys 55 to 59 are arranged on the front surface of the outer casing below the liquid crystal display panel 60 and the touch panel 54 in the using state of the apparatus with the outer casing 37 being held by hand. The outer casing 37 is provided with a jog dial 4 as later explained, a power source on/off switch 52, an insertion slot 53 for an external memory, as later explained, and housing sections for an external connection terminal 90 and a touch pen 51 used for transmission/reception of various data, similarly as later explained.

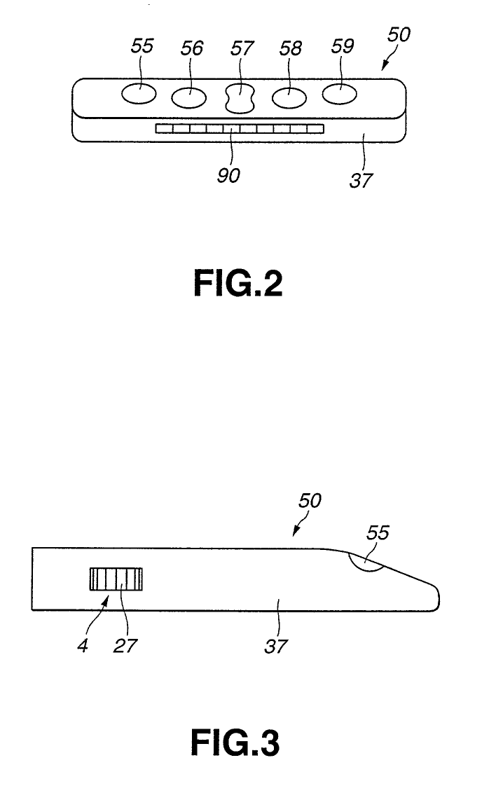

FIG. 2 shows, from a direction indicated by arrow A, the information processing apparatus 50 shown in FIG. 1. Referring to FIG. 2, the external connection terminal 90 of the present information processing apparatus 50 is connected to a dedicated connection device (so-called cradle device), not shown, of the apparatus 50, or to a general-purpose connection cable, to enable data transmission/reception with an external personal computer or a portable information terminal, including a portable telephone set. Meanwhile, if the information processing apparatus 50 includes an inner charging battery, a dedicated charging terminal may be provided on the external connection terminal 90 to effect electrical charging through the charging terminal. In addition, in order to prevent the external connection terminal 90 from contacting an extraneous object, the terminal 90 maybe provided at a recessed portion from the outer surface of the outer casing 37 or sheathed by a removable cover, not shown.

FIG. 3 shows, from a direction indicated by arrow B, the information processing apparatus 50 shown in FIG. 1. Referring to FIG. 3, the jog dial 4 of the information processing apparatus 50 of the present embodiment is arranged at a location where a dial portion 27 (disc-shaped operating knob) of the jog dial 4 is most likely to be touched with the thumb finger of the left hand of a user when the user holds the outer casing 37 of the apparatus 50 with the left hand so that the liquid crystal display panel 60 of the present embodiment is on the front side. Moreover, the dial portion 27 is mounted for being partially protruded from the surface of the outer casing 37 to provide for facilitated rotation and pushing (thrusting rotation) of the dial portion 27 with the thumb finger when the outer casing 37 is held with the left hand. The specified structure of the jog dial 4 will be explained subsequently.

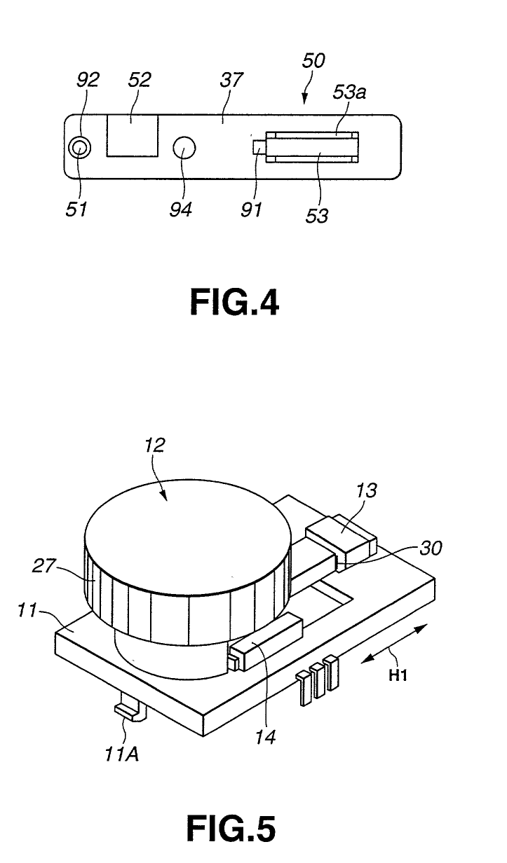

FIG. 4 shows the information processing apparatus 50, shown in FIG. 1, looking from the direction indicated by arrow C. In FIG. 4, the present information processing apparatus 50 includes a housing opening 92 for detachably housing the touch pen 51 in the direction indicated by arrow D in FIG. 1, an insertion slot 53 for an external memory medium as later explained and an ejection button 91 adapted for being pressed in taking out the external memory medium inserted into the slot 53. The insertion slot 53 may also be provided with a protective lug 53a shaped for protecting the external memory medium inserted therein and for facilitating the removal of the memory medium such as with a finger. The information processing apparatus 50 is also provided with an IR transmitting/receiving unit 94 for performing IR communication.

The various components arranged on the outer casing 37 of the information processing apparatus 50 shown in FIGS. 1 to 4 are hereinafter explained specifically.

The liquid crystal display panel 60 is made up of a liquid crystal display for monochromatic or color display and may also be provided with a backlight as necessary.

The touch panel 54 is comprised of a touch sensor which, when touched by e.g., the foremost part of the touch pen 51 that may be detachably mounted and housed in the outer casing 37, is able to detect at least a contact position, a contact trajectory and so forth. The touch panel 54 is roughly made up of a transparent sensor portion transparent sensor portion 54a, arranged on the liquid crystal display panel 60, and an opaque sensor portion 54b, arranged e.g., below the display surface of the liquid crystal display panel 60. The detection area of the opaque sensor portion 54b is functionally divided into plural sub-areas. That is, in the embodiment shown in FIG. 1, the detection area of the opaque sensor portion 54b of the touch panel 54 is functionally divided into an input area 41, used for inputting freehand letters or characters, mainly by the touch pen 51, an input area 40 used for inputting freehand numerical figures with the touch pen 51, and a stationary area associated with an icon 45 used for displaying a launcher picture as later explained on the liquid crystal display panel 60, an icon 46 used for display indication of a menu picture on the liquid crystal display panel 60, an icon 44 used for commanding e.g., kana-kanji conversion in creating a text, an icon 67 used for commanding letter finalizing operations in creating a text, an icon 47 used for commanding katakana/hiragana inputting switching, an icon 48 for commanding Japanese/English inputting switching and an icon 43 commanding screen keyboard display.

Of the keys 55 to 59, the key 55 is a key pressed for booting a schedule table software among the application software installed on the apparatus 50, the key 56 is a key pressed for booting an address book management software, among the application software items, the key 58 is a key pressed for booting a software used for displaying items to be done (so-called to-do software) among the application software items, and the key 59 is a key pressed for booting a memo book software among the application software items. The key 57 is made up of an upper switch portion upper switch portion 57a and a lower switch portion 57b for sliding a scroll bar in a window picture displayed on the liquid crystal display panel 60 upwards and downwards, respectively.

The jog dial 4 is now explained. The jog dial 4 is a specified example of a rotating type electronic component fitted with a push switch as disclosed in the Japanese Laying-Open Publication H-8-203387 filed in the name of the present Assignee and a joint Assignee.

This jog dial 4 is comprised of a contact mounting substrate 11 carrying a rotating type encoding unit 12 and a push switch unit 13 thereon, as shown in FIG. 5. The rotating type encoding unit 12 is movable horizontally within a certain extent, while the push switch unit 13 is fixed against movement.

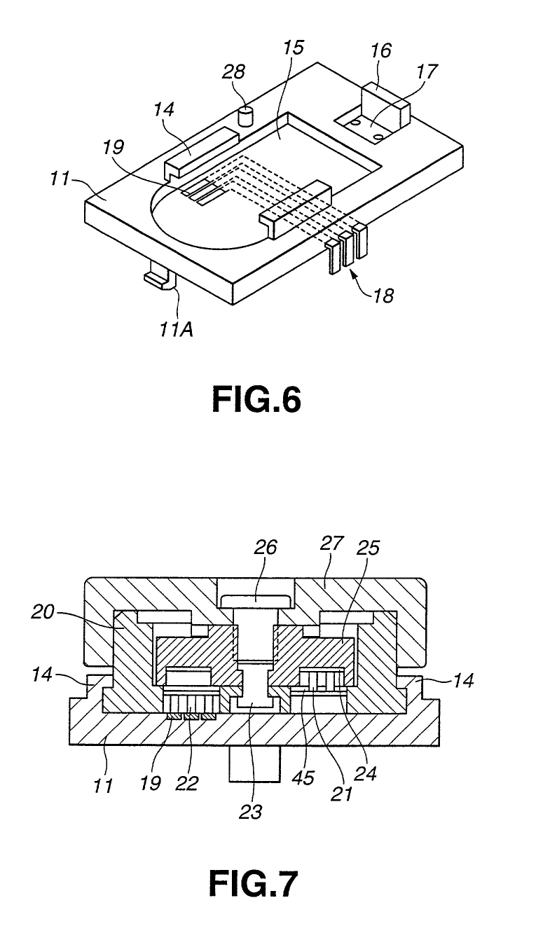

Referring to FIG. 6 the contact mounting substrate 11 is comprised of a flat molded resin plate carrying a recess 15, presenting a guide rail 14 for guiding the movement of the rotating type encoding unit 12, a recess 17 presenting a stop wall section for fixing the push switch unit 13 in position, and a contact plate 19 having a terminal 18 for transmitting electrical signals of the rotating type encoding unit 12 to outside, as shown in FIG. 6.

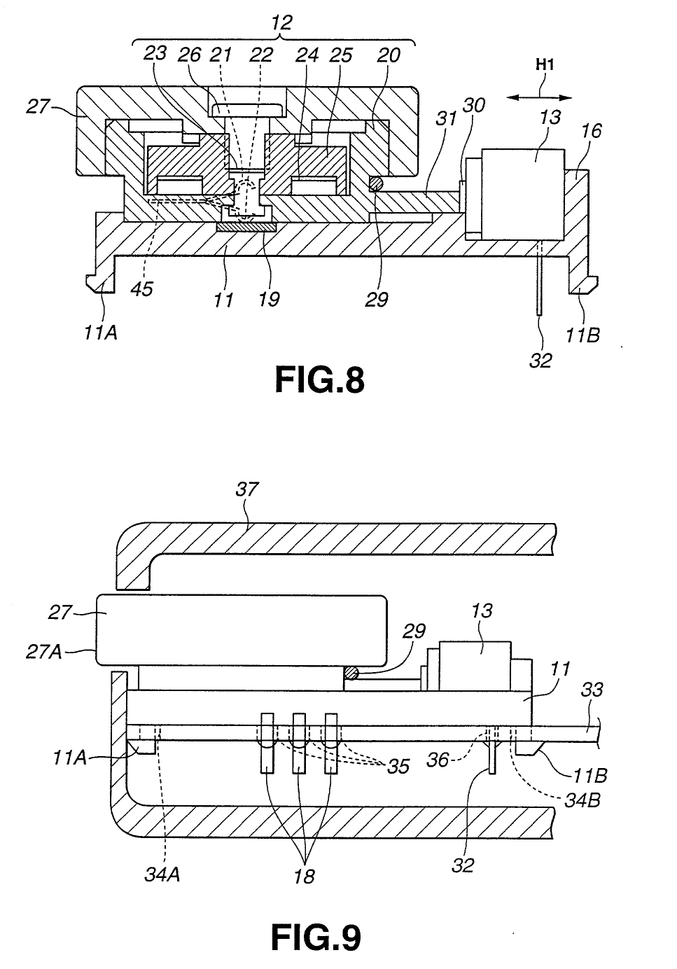

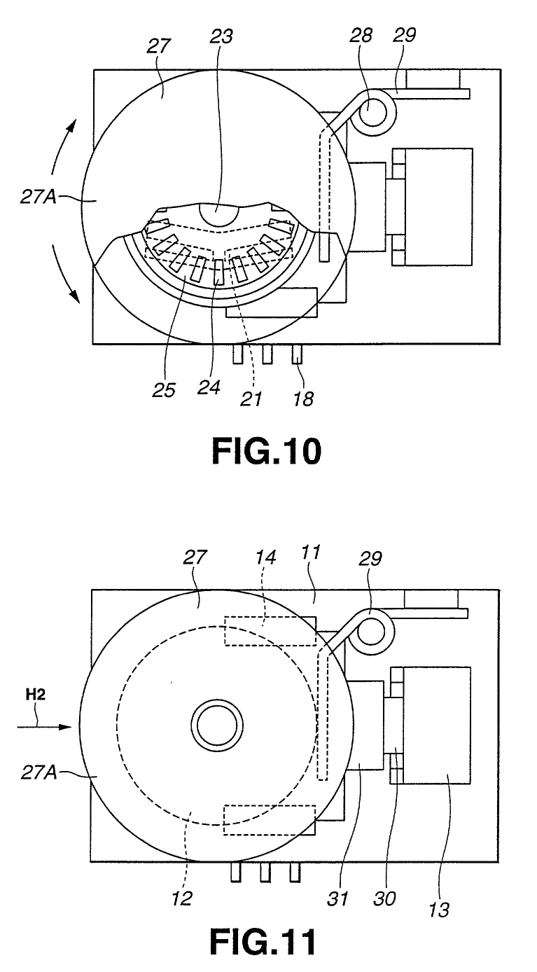

Referring to FIGS. 7 and 8, the rotating type encoding unit 12 includes a box-shaped casing 20 of molded synthetic resin, fitted in the recess 15 of the contact mounting substrate 11 and held by the guide rail 14 for movement horizontally within a pre-set extent in the direction indicated by arrow H1 in FIGS. 5 and 8. The rotating type encoding unit 12 also includes resilient contact legs 21, 22 protruded upwards and downwards, respectively, from a resilient contact member 45 mounted by insert molding on the bottom surface of the box-shaped casing 20. The rotating type encoding unit 12 also includes a disc-shaped rotating member 25 of molded resin having a radially extending contact plate 24 elastically contacted by the resilient contact leg 21 on its lower surface. The rotating member 25 is supported for rotation by a columnar-shaped shaft 23 formed as one with a mid portion of the box-shaped casing 20. The rotating type encoding unit 12 also includes a dial portion 27, as a disc-shaped operating knob of the type actuated on its outer rim, attached on an upper portion of the rotating member 25 with a screw 26 for rotating the rotating member 25. A torsion coil spring 29, positioned on a pin projection 28 on the contact mounting substrate 11 (FIGS. 6 and 10), horizontally thrusts the lateral surface of the box-shaped casing 20 so that, in the normal state, the rotating member 25 is biased to a position spaced apart from the push switch unit 13. The resilient contact leg 22, projected downwards from the bottom surface of the box-shaped casing 20, elastically acts on a contact plate 19 of the contact mounting substrate 11.

Referring to FIGS. 5 and 6, the push switch unit 13 is fitted in position in the recess 17 of the contact mounting substrate 11 so that the operating portion 30 faces the rotating type encoding unit 12, with the rear end of the push switch unit 13 compressing against the stop wall section 16.

Referring to FIG. 8, a driving lug 31, formed as one with the box-shaped casing 20 of the rotating type encoding unit 12, compresses against the foremost part of the operating portion 30 of the push switch unit 13. In mounting the above-described jog dial 4 on an electronic equipment, the legs 11A, 11B on the lower surface of the contact mounting substrate 11, the connection terminal 18 of the rotating type encoding unit 12 and a connection terminal 32 of the push switch unit 13 are intruded and soldered in mounting holes 34A, 34B, 35 and 36 formed in a printed wiring board 33 of the equipment, respectively. The jog dial 4 is mounted on the rotating type encoding unit 12 so as to be protruded at the dial portion 27 outwards from a gap of the outer casing 37 of the equipment on the opposite side to the push switch unit 13, as shown in FIG. 9.

The operation of the jog dial 4 is now explained. Referring to FIGS. 9 and 10, a protruding portion 27A of the dial portion 27 mounted on the upper end of the rotating type encoding unit 12 from the outer casing 37 is rotated by applying a tangential force thereto, so that the rotating member 25 is rotated about the columnar-shaped shaft 23 of the box-shaped casing 20 as the center of rotation. This causes rotation of the rotating member 25 about the columnar-shaped shaft 23 at the mid portion of the box-shaped casing 20 as the center of rotation to cause the upper resilient contact leg 21 to slide in resilient contact over the radially extending contact plate 24 on the lower surface of the rotating member 25, so that pulse signals associated with the rotation of the dial portion 27 are generated at the contact portion. Each pulse corresponds to one click, as will be explained subsequently.

These pulse signals are transmitted from the upper resilient contact leg 21 to the lower resilient contact leg 22 and thence to the contact plate 19 on the contact mounting substrate 11 resiliently contacting the resilient contact leg 22. Finally, the pulse signals are transmitted to the printed wiring board 33 of the electronic equipment through an external connection terminal 18.

Referring to FIG. 11, a thrusting force operating in the horizontal direction interconnecting the center of the knob and the push switch unit 13, that is in the direction indicated by arrow H2, is applied to the protruding portion 27A of the dial portion 27, against the bias of the torsion coil spring 29 on the contact mounting substrate 11, for moving the rotating type encoding unit 12 in its entirety in the horizontal direction along the guide rail 14 of the contact mounting substrate 11, until the lug 31 provided on the box-shaped casing 20 thrusts the operating portion 30 to actuate the push switch unit 13 to generate an electrical signal which is then transmitted to a circuitry of the printed wiring board 33 of the electronic equipment through the connection terminal 32 shown in FIG. 9.

If the thrusting force applied to the dial portion 27 is removed, the rotating type encoding unit 12 is reverted to its state shown in FIG. 10 under the resilient reverting force of the torsion coil spring 29 of the contact mounting substrate 11.

In the foregoing explanation, the electrical signals of the rotating type encoding unit 12 are transmitted to the connection terminal 18 of the contact mounting substrate 11 by the resilient contact leg 22 protruded downwards from the bottom surface of the box-shaped casing 20 of the rotating type encoding unit 12. Alternatively, the resilient contact leg may be protruded from the contact mounting substrate 11 into resilient contact with the contact plate provided on the bottom surface of the box-shaped casing 20. The above is the explanation of the structure and the operation of the jog dial 4 provided on the right side surface of the outer casing 37.

Of course, the jog dial 4 may be provided at an optional suitable position other than the mounting position shown in FIG. 1.

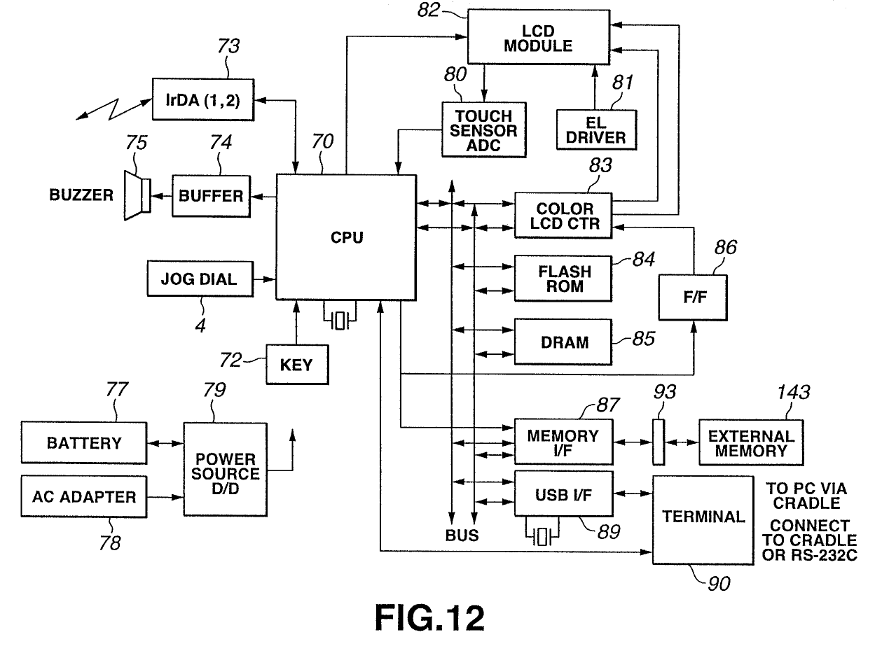

The inner circuit structure of the information processing apparatus 50 embodying the present invention is now explained by referring to FIG. 12. The respective component parts are hereinafter explained.

In FIG. 12, a CPU 70 controls the respective components based on each program written in a flash ROM 84, while performing a variety of processing operations pertinent to the operation of the present jog dial 4, as later explained, and processing operations pertinent to the respective software items, such as schedule tables, memo books or address books, in accordance with data read out from the flash ROM 84 or with the application software captured from an external memory medium 143 and developed in a DRAM 85.

A color LCD control unit 83 actuates the liquid crystal display panel 60 for color display, provided in an LCD module 82, via flipflop 86, under control by the CPU 70. The LCD module 82 includes an electro-luminescence (EL) panel, as a backlight for the liquid crystal display panel 60 capable of color display. This EL panel is driven by an EL driver 81.

This LCD module 82 also includes the touch panel 54, a touch detection signal of which is routed to an analog/digital converter (ADC) 80. The touch detection signal, converted by the ADC 80 into digital signals, is routed to the CPU 70, which then verifies, from the touch detection signal, which detection area has been touched by the user with the touch pen 51, to control the various components based on the detected area.

An IrDA 73 includes an LED and a photodetector making up the transmission/reception unit 94 for IR communication, a driver for actuating the LED for light emission responsive to the signal transmitted from the CPU 70 and a reception signal processor for converting light reception signal of the photodetector into digital signals which are transmitted to the CPU 70.

A buffer 74 has the function of amplifying speech signals from the CPU 70 to drive a buzzer (loudspeaker) 75 by the amplified speech signals.

The battery 77 is e.g., a battery or a storage cell, the driving current of which is sent to a power source unit 79. An application category adapter 78 converts the application category voltage into DC voltage for supply to the power source unit 79 if an external application category source is used. The power from the power source unit 79 is supplied to each component of the information processing apparatus 50.

The key 72 is the aforementioned keys 55 to 59, the signals from which are sent to the CPU 70. The CPU 70 controls the various components and booting of the application software based on these signals from these keys 55 to 59.

The USB (universal serial bus) interfacing unit 89 converts the format of signals transmitted/received by the USB format with e.g., a personal computer through a dedicate connection device, or a so-called cradle device, connected to the external connection terminal 90. The external connection terminal 90 can also be connected to e.g., a universal connection cable, such as RS-232C, so that data is transmitted/received over the RS-232C cable with the CPU 70.

A memory interfacing unit 87 performs processing, such as format conversion of data transmitted/received between it and the external memory medium 143 connected to an external memory connection terminal 93.

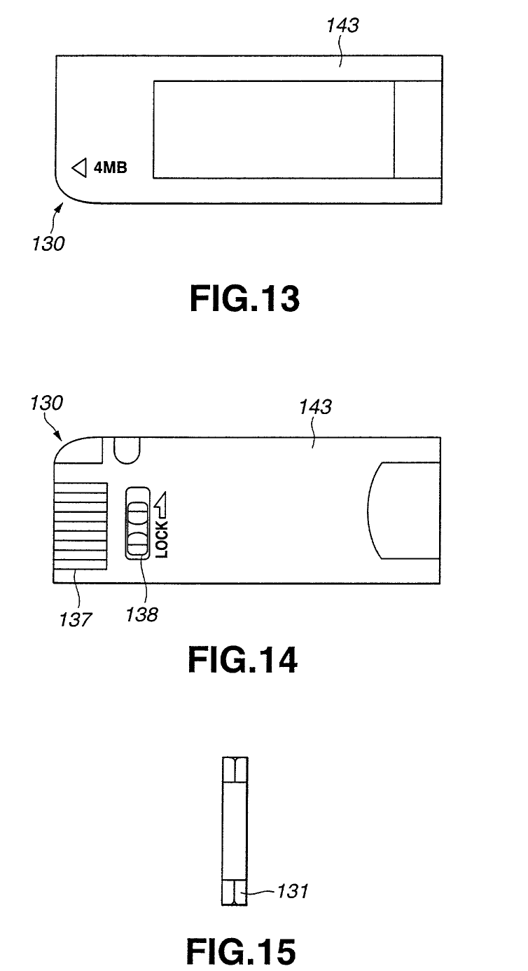

FIGS. 13 and 14 show the appearance of a typical external memory medium, as the aforementioned external memory medium 143, comprised of a semiconductor memory enclosed in a casing in the form of a stick-shaped or a plate-shaped chewing gum. FIGS. 13, 14 and 15 show the front side, back side and the right side of the external memory medium 143, respectively.

Referring to FIGS. 13 to 15, the external memory medium 143 is provided with a cut-out 130, and the external memory medium 143 is intruded into the slot 53 from the direction of the cut-out 130.

The external memory medium 143 includes a terminal portion 137 connected to the connection terminal provided in the slot 53 of the present information processing apparatus 50 and a write inhibit lock 138 for inhibiting the data writing.

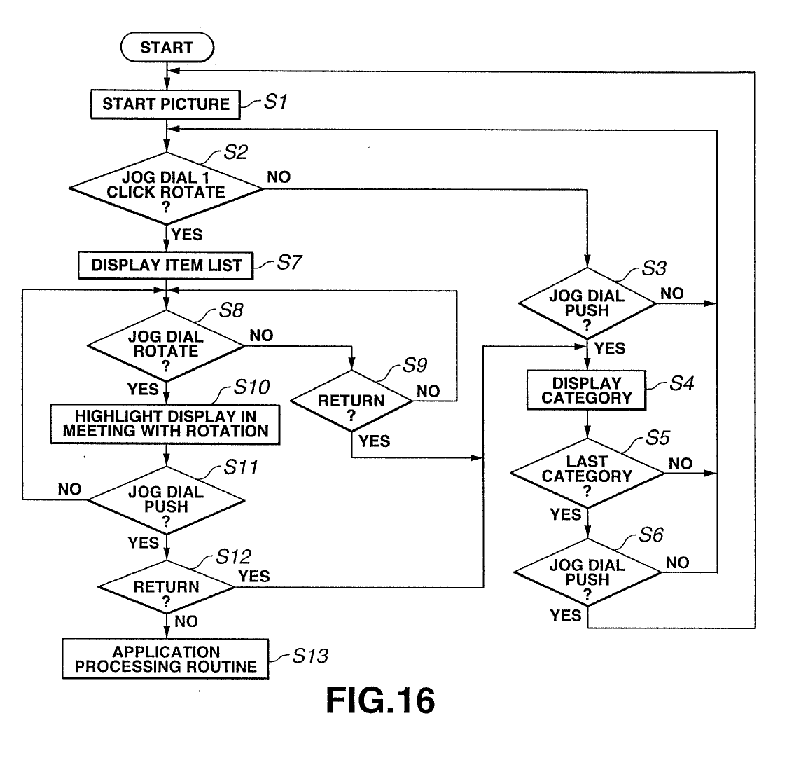

Referring to FIGS. 16 to 29, display transition by the CPU 70 controlling the processing responsive to the operation of the jog dial 4 and by the CPU controlling the display state of the liquid crystal display panel 60 responsive to the processing is now explained.

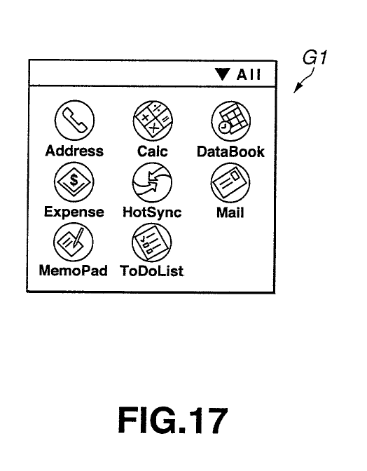

First, referring to the flowchart of FIG. 16 and to FIGS. 17 to 21, transition of display states on the liquid crystal display panel 60 of the present information processing apparatus 50 is explained.

If, in FIG. 16, the power source on/off switch 52 of the present information processing apparatus 50 is actuated to turn the power source on, the CPU 70 controls the color LCD control unit 83, by way of the processing at step S1, to display a start picture G1, shown in FIG. 17, on the display screen of the liquid crystal display panel 60 of the LCD module 82. In the start picture G1 are displayed icons for booting the various application software items installed in the present apparatus 50. In the embodiment shown in FIG. 17, an icon for the address book software (Address), an icon for a table calculator software (Calc), an icon of a schedule table software (Data Book), an icon of the payment memo software (Expense), an icon of the software for transmitting/receiving an E-mail over a personal computer (Hot Sync: trade mark of the Palm. Inc), an icon for an E-mail software (Mail), an icon for a memo book software (Memo Pad) and am icon of a to-do-software (To-Do List), are displayed.

In this state, the CPU 70 is monitoring the status of the dial portion 27 of the jog dial 4 . That is, the CPU 70 monitors, as step S2, whether or not the dial portion 27 of the jog dial 4 has been rotated at least for one click, while monitoring, at step S3, whether or not the dial portion 27 has been pushed. If the CPU 70 has detected that the dial portion 27 has been rotated by one clock, the CPU 70 proceeds to the processing at step S7.

If the CPU 70 has detected that rotation for one click has not been completed, but the dial portion 27 has been pushed, it proceeds from the processing at step S3 to the processing at step S4.

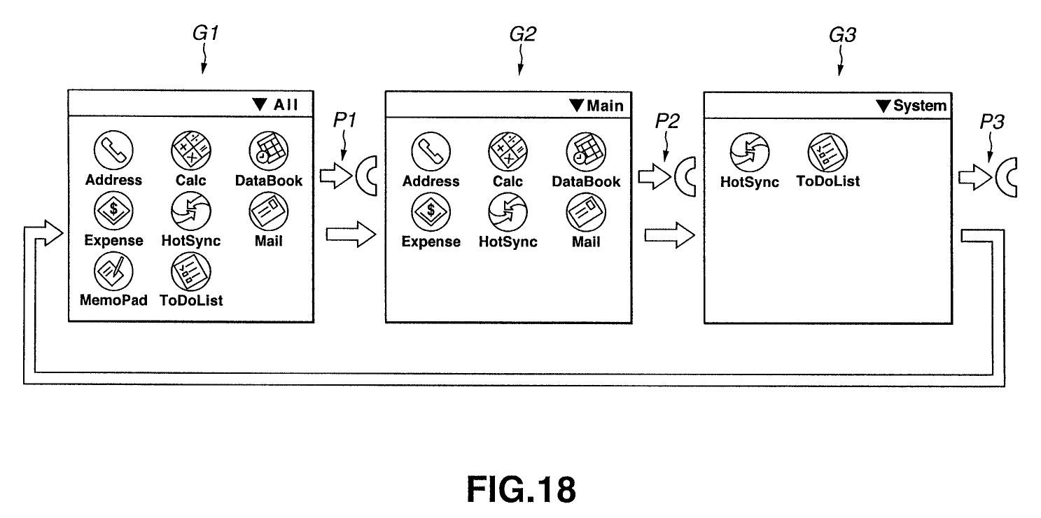

At step S4, the CPU 70 switches the operating mode of the apparatus 50 from the operating mode responsive to the touch panel actuation to that responsive to the jog dial actuation, while switching the display state on the liquid crystal display panel 60 from the start picture G1 in FIG. 17 to the category-based display state as shown in FIG. 18. The category means the class of the application software items installed in the apparatus 50. In the following explanation, this application-based category is termed an application category. In the classification processing for the application categories, the CPU 70 may be automatically performing the processing responsive to the contents of the software or other parameters, or may be automatically performing the processing based on the list of classification as set previously by the user.

Next to this step S4, the CPU 70 verifies, by way of the processing at step S5, whether or not the application category for the time being is the ultimate (last) classification category. If the application category for the time being is decided not to be the ultimate classification category, the CPU reverts to the processing at step S2. If the application category for the time being is decided to be the ultimate classification category, the CPU at step S6 verifies whether or not the dial portion 27 has been further pushed. If the dial portion 27 is decided not to have been pushed, the CPU 70 reverts to the processing at step S2 and, if the dial portion 27 is decided to be pushed, the CPU 70 reverts to the processing at step S1.

By this processing from step S2 to step S6, the display state on the liquid crystal display panel 60 is switched from the start picture G1 to pictures G2, G3 associated with the next application category, each time the dial portion 27 is pushed, with the display state reverting to the start picture G1 after the picture G3 of the last classification category. In the embodiment of FIG. 18, the display state is switched to the picture G2 displaying each icon of the application software classified to the next application category, by a pushing operation P2 of the dial portion 27 in the state of the start picture G1. Also, the display state is switched to the picture G3 displaying each icon of the application software classified to the next application category, by a pushing operation P2 of the dial portion 27, while being switched to the start picture G1 (that is, the picture displaying the icons of the application software of the application categories in their entirety) by a pushing operation P3 of the dial portion 27.

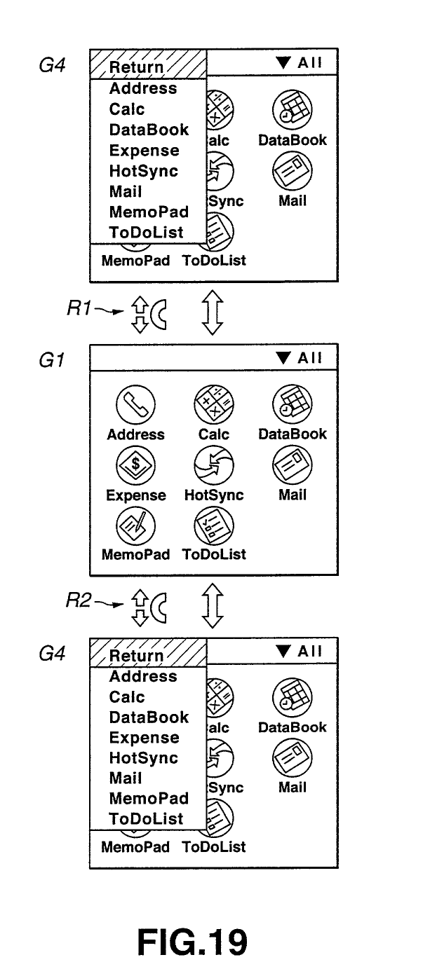

Next, if, in the processing at step S2, the dial portion 27 of the jog dial 4 is verified to have been rotated by one click, such that the CPU 70 proceeds to step S7, the CPU 70 switches the operating mode of the apparatus 50 to a mode associated with the operation of the jog dial 4 to switch the display on the liquid crystal display panel 60 to an initial display picture G4 of the item list shown in FIG. 19. The item list shows e.g., the abbreviations of the application software items classified as being the application categories at the current time point in the form of a pull-down menu (so-called launcher display). In the following description, the item list representing the list of the respective application software is termed an application item list. In the picture G4 shown in FIG. 19, there are displayed abbreviations of respective application software items, for which the application category classification is made, the entire application categories herein, in the start picture G1 as items of the pull-down menus of the application item list. That is, in the picture G4 of FIG. 4, an abbreviation of the address book software (Address), an abbreviation of the electronic calculator software (Calc), an abbreviation of a scheduled table list (Data Book), an abbreviation of a payment memo software (Expense), an abbreviation of a software for transmitting/receiving an E-mail through a personal computer (Hot Sync: trade mark of the 3 Com Corporation), an abbreviation of an E-main software (Mail), an icon for a memo book software (Memo Pad), an abbreviation of the To-Do Software (To-Do List) are displayed, while a return [Return] is also displayed as a menu item of the uppermost line of the pull-down menu.

Meanwhile, although there are two rotational directions of the dial portion 27, display is switched from the start picture G1 to the initial display picture G4, if the picture before rotation for one click is the display state of the start picture G1, no matter to which of the rotational operations R1 and R2 corresponds the one click rotating direction of the dial portion 27. If, as a result of the rotational operations R1 or R2, the display state is switched from the start picture G1 to the initial display picture G4 for the application item list, and the dial portion 27 is subsequently rotated in a direction opposite to the direction of the previous rotation, the display state may revert to the start picture G1 or may continue to display the initial display picture G4 for the application item list.

When the display state is the initial display picture G4 for the application item list, the CPU 70 is monitoring, as a processing of step S8, whether or not the dial portion 27 has been further rotated, while also monitoring, as a processing of step S9, whether or not, as the item [Return] of the pulldown menu items of the application item list is shown highlighted, the dial portion 27 has been pushed.

It should be noted that if, at step S9, as the item [Return] of the application item list, is shown highlighted, the dial portion 27 is detected as not having been pushed, the CPU 70 reverts to the processing at step S8. On the other hand, if, at step S9, as the item [Return] of the application item list has been shown highlighted, the dial portion 27 is detected as having been pushed, the CPU reverts to processing of application category display at step S4. That is, in this case, the display on the liquid crystal display panel 60 reverts to the directly previous application category display picture.

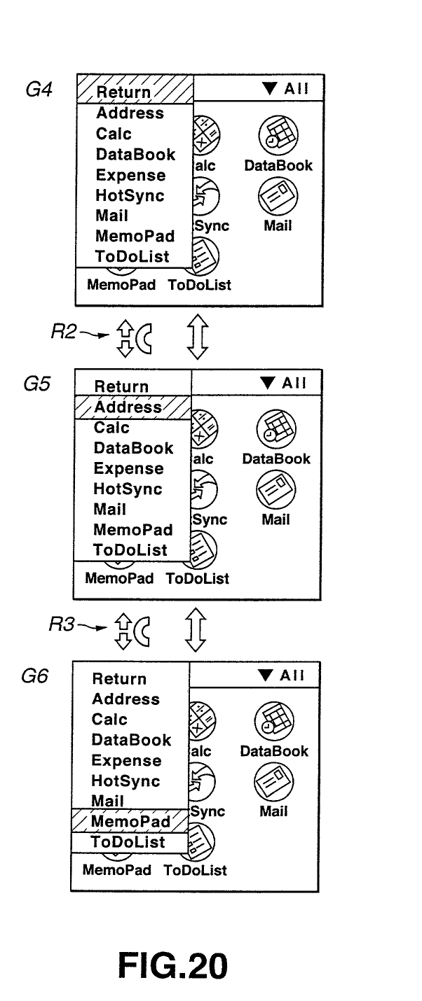

Next, if it is detected at step S8 that the dial portion 27 has further been pushed, the CPU 70 proceeds to step S10. At this step S10, the CPU 70 is responsive to the amount of rotation of the dial portion 27 (the number of rotating clicks) to change the highlighted display position of each menu item of the application item list. That is, the display state on the liquid crystal display panel 60 in this case is such that, each time the dial portion 27 is rotated for one clock, the highlighted display position of each menu item on the application item list is changed depending on the direction of rotation, as shown in FIG. 20. Meanwhile, in the embodiment of FIG. 20, if the rotational operation R2 for one click is made for the initial display picture G4 for the application item list, the display state is switched to a picture G5 showing the next menu item [Address] highlighted. If then the dial portion 27 is rotated by the rotational operation R3 for six clicks the display status is switched to a picture G6 showing the menu item [Memo Pad] of the application item list highlighted.

If, after the processing at step S10, the CPU 70 proceeds to the processing at step S11, the CPU 70 detects, as one of the items of the pulldown menu items of the application item list is shown highlighted, whether or not the pushing operation of the dial portion 27 has been made. If it is verified that the pushing operation has been made, the CPU proceeds to step S12.

If the CPU is at the processing at step S12, the CPU verifies whether or not, as the pushing operation of the dial portion 27 has been made, the item shown highlighted among the pulldown menus of the application item list is the above item [Return]. If the CPU 70 has verified that the item is not the item [Return], the CPU proceeds to processing at step S13.

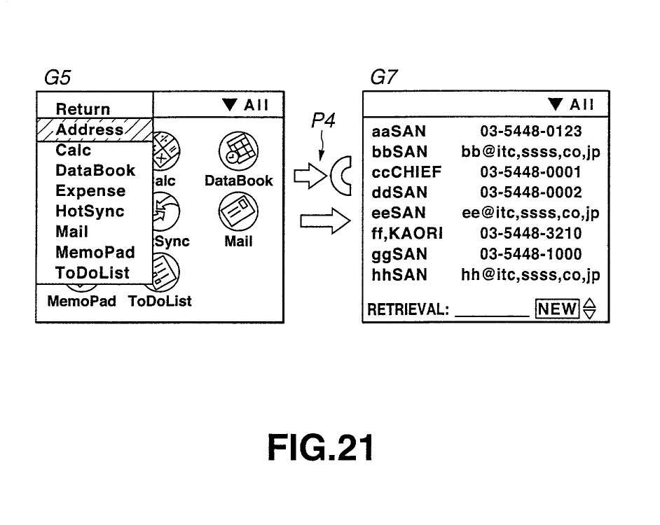

At step S13, the CPU 70 boots the application software associated with the item shown highlighted, among the pulldown menus of the application item list, and shifts to the processing routine of the application software. FIG. 21 shows the state in which the application software associated with the menu item [Address] is selected by the pushing processing P4 such that the start picture G7 for the application software has been displayed.

On the other hand, if the item shown highlighted among the pulldown menus of the application item list when the pushing operation of the dial portion 27 has been made is verified at step S12 to be the aforementioned item [Return], the CPU 70 reverts to the processing for application category display at step S4. That is, in this case, the display on the liquid crystal display panel 60 reverts to the directly previous application category display picture.

It no input has been made for a pre-set time period, automatic return may be made at step S9. In this case, the processing at step S12 is redundant.

In the present information processing apparatus 50, described above, the operating mode in the CPU 70 can be automatically switched from an operating mode other than the operating mode associated with the operation of the jog dial 4 to an operating mode performing a processing associated with the operation of the jog dial 4 . Thus, the user is able to learn intuitively that, as a result of the operation on the jog dial 4, the processing mode transfers to a processing mode associated with the operation on the jog dial 4. That is, the user is able to intuitively learn the above transfer on viewing the display on the application item list resulting from the one-click rotation of the jog dial 4.

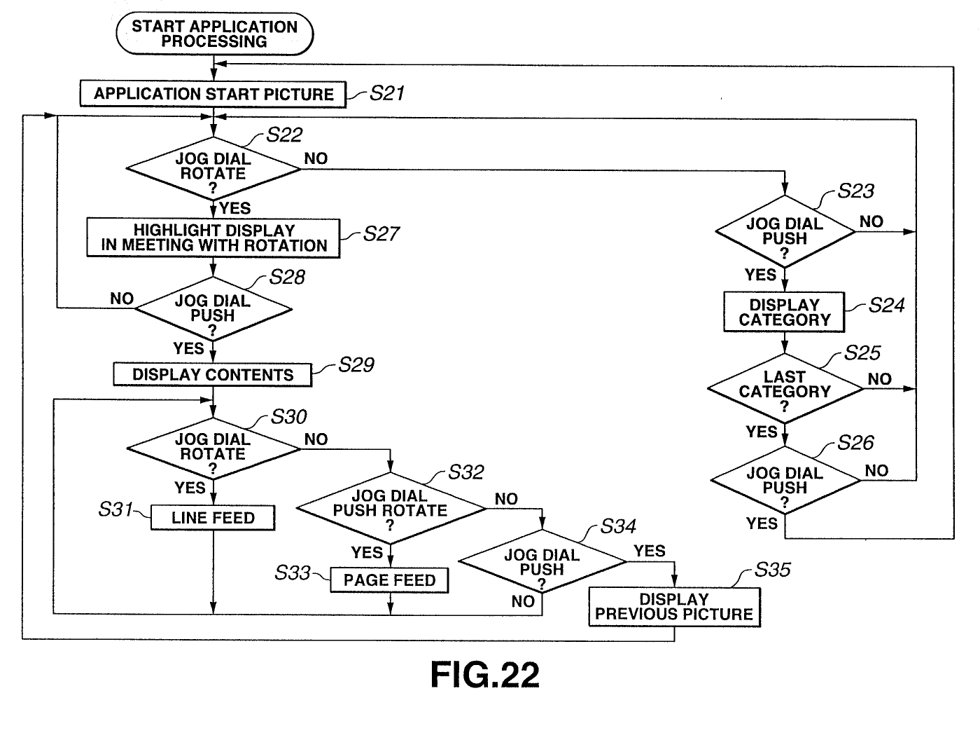

The portion of the processing routine of the application software associated with the operation of the jog dial 4 in case the CPU 70 proceeds to the processing at step S13 in the flowchart of FIG. 16, such that the appellation software associated with the item shown highlighted among the pulldown menus of the application item list is booted, is now explained with reference to FIGS. 22 to 29.

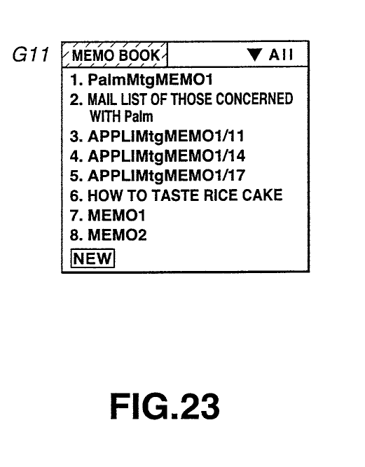

Referring to the flowchart of FIG. 22 and to FIGS. 23 to 29, the transition of the display state on the liquid crystal display panel 60 of the information processing apparatus 50 of the present embodiment in case a memo book software, for example, is booted as an application software, is hereinafter explained.

If the memo book software, for example, is booted in FIG. 22, the CPU 70 first causes a start picture G11 of the application software (memo book software), shown in FIG. 23, to be demonstrated on the display screen of the liquid crystal display panel 60. In the start picture G11 of the application software (memo book software), shown in FIG. 23, memo books, already registered or not as yet registered, are displayed as a list as an item list in the application software of the memo books. In the following description, the item list in the application software is specifically termed an information item list.

In this state, the CPU 70 is monitoring the status of the dial portion 27 of the jog dial 4. That is, the CPU is monitoring at step S22 whether or not the dial portion 27 of the jog dial 4 has been rotated at least for one click, while also monitoring, at step S23, whether or not the dial portion 27 has been pushed. If the CPU 70 has detected that the dial portion 27 has been rotated for one click, it proceeds to the processing at step S27.

On the other hand, if the CPU 70 has detected that the dial portion 27 has not been rotated for one click, but has been pushed, the CPU proceeds from step S23 to processing at step S27

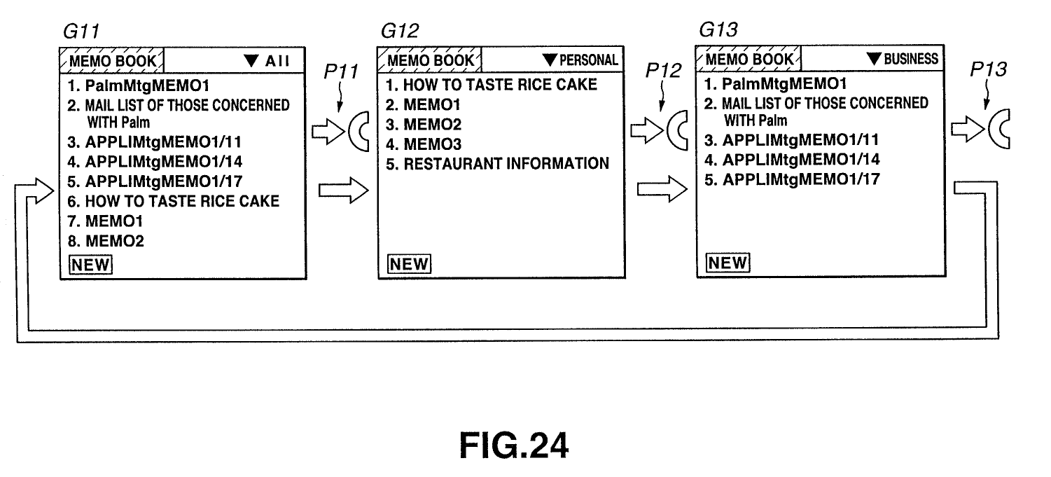

At step S24, the CPU 70 switches the display state on the liquid crystal display panel 60 from the application start picture G11 of FIG. 23 to the category-based display state shown in FIG. 24. The category herein means files or holders handled by the currently running application software, other processing units, such as memos of memo book software, addresses of the address book software, schedules of E-mail software and classification of processing units handled by each software, such as To-Do software. In the following explanation, this category is specifically termed the information category. The classification processing of the information category may be automatically performed by the CPU 70 responsive to the information in the processing unit handled by the information in the processing unit or other parameters handled by the application software, or on the basis of the classification list previously set by the user.

Next to this step S24, the CPU 70 at step S25 verifies whether or not the information category at the current time point is the final classification category. If the CPU 70 has verified that the category is not the last classification category, it reverts to the processing at step S22. If conversely the CPU 70 has found that the information category is the last classification category, the CPU 70 at step S26 verifies whether or not the dial portion 27 has been pushed further. If the CPU has verified that the dial portion 27 has not been pushed, it reverts to step S22 and, if otherwise, it reverts to step S21.

That is, by the processing from steps S21 and S22 up to step S26, the display state on the liquid crystal display panel 60 is switched from an application start picture G11 to pictures G12 and G13 associated with the next information category, each time the dial portion 27 is pushed, and reverts to the application start picture G11 next to the last classification category picture G13, as shown in FIG. 24. Meanwhile, FIG. 24 shows such a state in which, by the push operation P11 by the dial portion 27 in the application start picture G11, the display state is switched to the picture G12 displaying the information item list classified to the next information category, here the item of each memo. By the next push operation P12 by the dial portion 27, the display state is switched to the picture G13 displaying the information item list classified to the next information category (memo), that is the picture of the last classification category. By a further push operation P3 by the dial portion 27, the display state is switched to the application start picture G11 (the picture showing the information item list of the entire information category).

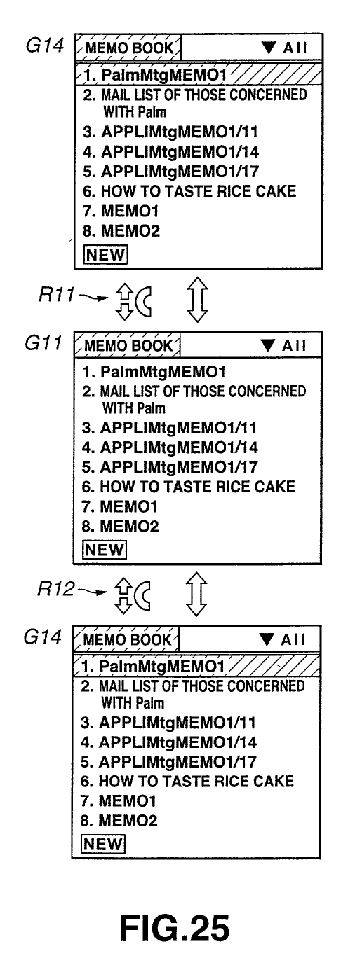

If it is verified at step S22 that the dial portion 27 of the jog dial 4 has been rotated by one click, so that the CPU 70 proceeds to step S27, the CPU switches the display on the liquid crystal display panel 60 to a picture G14 in which the leading list item, for example, of the information item list of each memo shown in FIG. 25 is shown highlighted, as shown in FIG. 25. Meanwhile, in the display state of the application start picture G11, the display is switched from the G11 to the picture G14 no matter whether the direction of the one-click rotation of the dial portion 27 is the rotating operation R1 or R2. The display state may revert to the application start picture G11 or continue to be the display state of the picture G4 if, after switching from the application start picture G11 to the picture G4 by the rotating operation R1 or R2, the dial portion 27 is rotated in the opposite direction to that of the previous rotating operation.

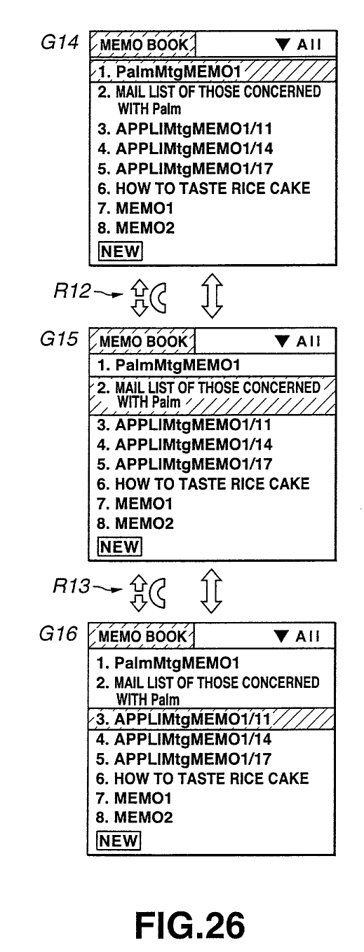

If, at this step S27, the CPU 70 has detected that the dial portion 27 has further been-rotated, the highlighted position of the list item is changed responsive to the amount of rotation of the dial portion 27, that is the number of rotating clicks, as shown in FIG. 26. Thus, in this case, the display state on the liquid crystal display panel 60 is such that, each time the dial portion 27 is rotated one click, the highlighted display position of the list item is changed depending on the rotating direction, as shown in FIG. 26. Meanwhile, FIG. 26 shows that, by the one-click rotating operation R12 for the picture G14, the display state is switched to a picture G15 showing the next list item ([mail list of those concerned with Palm]) highlighted and that, by the one-click rotating operation R13 of the dial portion 27, the display state is switched to the picture G15 showing the list item ([appliMtg memo 1/11]) highlighted.

When the CPU 70 proceeds after step S27 to step S28, it detects, as one of the list items is shown highlighted, whether or not the pushing operation, for example, of the dial portion 27 has been pushed. If it is verified that the pushing operation has been performed, the CPU 70 proceeds to step S29.

At the processing at step S29, the CPU 70 displays, on pushing operation of the dial portion 27, the information items of the information list item, shown highlighted, here memo contents.

The CPU 70 then detects at step S30 whether or not the dial portion 27 has been rotated, while detecting at step Second water washing mechanism 32 whether or not the dial portion 27 has been pushed and rotated, that is whether or not the dial portion 27 has been rotated as it is pushed, while detecting at step S34 whether or not the dial portion 27 has been pushed.

If it is detected at step S30 that the dial portion 27 has been rotated, the CPU 70 at step S31 line-feeds the information contents displayed at the previous step S29 to then revert to step S30. If it is detected at step Second water washing mechanism 32 that the dial portion 27 has been pushed and rotated, the CPU 70 at step Second water washing mechanism 32 page-feeds to display the next page to the information contents displayed at the current time point to then revert to step S30. On the other hand, if it is detected at step S30 that the dial portion 27 has been rotated, the CPU 70 at step S35 displays the contents of the previous display to then revert to step S30.

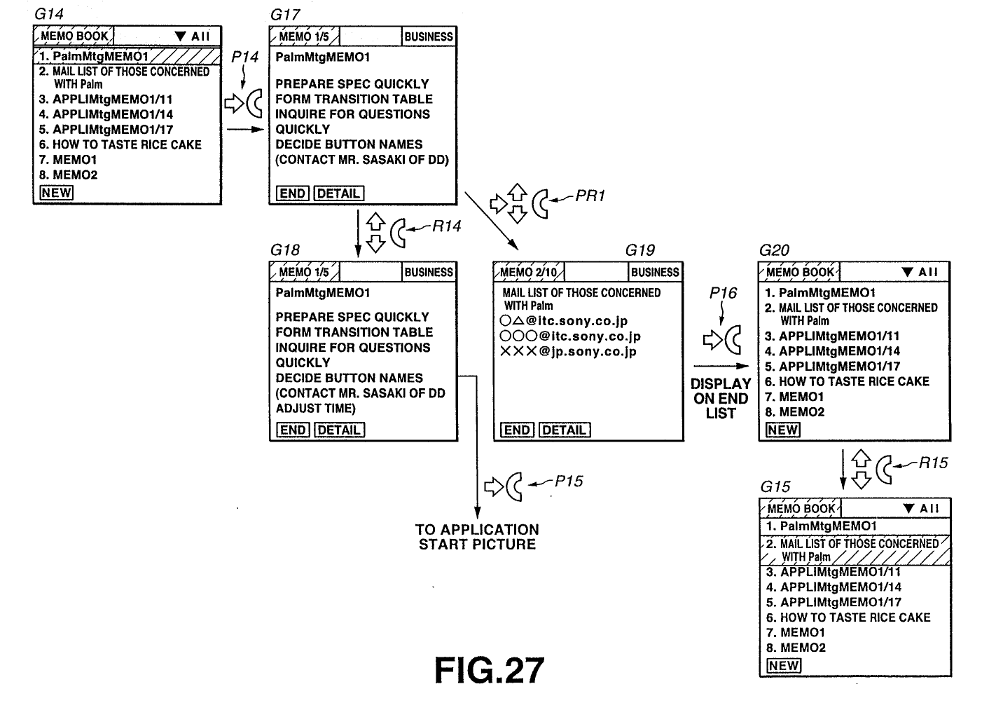

By way of a specified illustrative display of the processing from step S29 to step S35, if the dial portion 27 is pushed (P14) as the picture G14 is displayed, memo contents shown in the picture G17 are displayed, as shown in FIG. 27. If, in the state of the picture G17, the dial portion 27 is rotated (R14), there is displayed a line-fed picture (G18). If, in the state of the picture G18, the dial portion 27 is pushed (Pre-flux forming mechanism 15), the display state reverts to the application start picture (G14). If, in the state of the picture G17, the dial portion 27 is pushed and rotated (PR1), there is displayed a page-fed picture (G19). If the dial portion 27 is further pushed (P16) in the state of the picture G19, the display state is switched to an end list display picture (G20). If, in the state of the end list display picture G20, the dial portion 27 is rotated (R15), the contents of the previous display are displayed (G15).

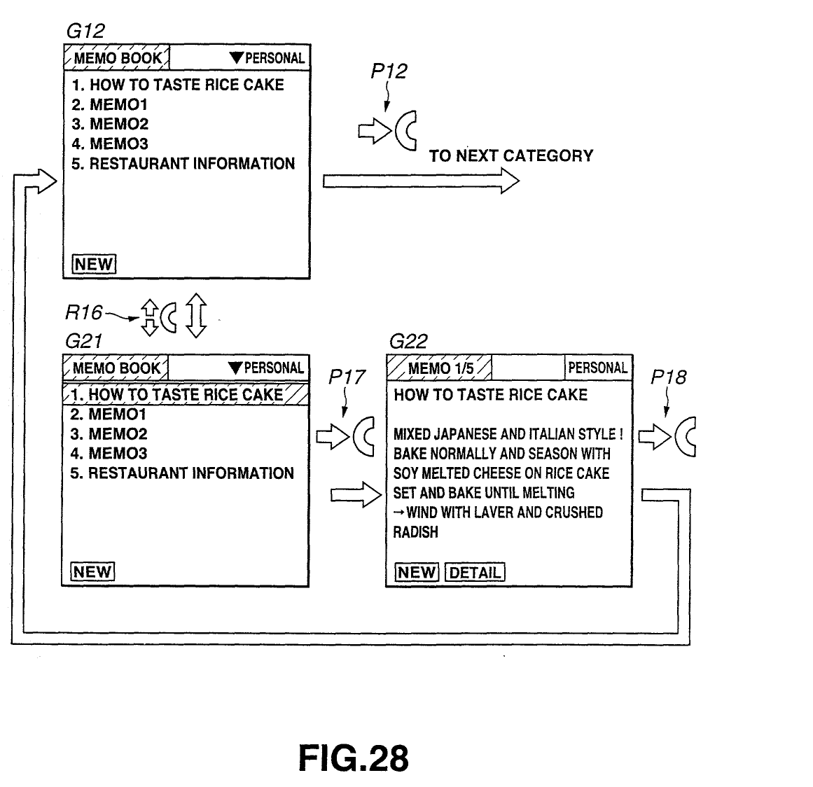

FIG. 28 shows a typical display transition when the information category display of picture G12 of FIG. 24 is made. If, in FIG. 28, as the picture G12 is demonstrated, the dial portion 27 is rotated (R16), the highlighted display of the information item list is modified as shown in the picture 21. If further the push operation P 17 is made, the memo contents associated with the highlighted list item are demonstrated (G22). If, in the state of the picture G22, the dial portion 27 is pushed (P18), the contents of the previous display (G12) are demonstrated.

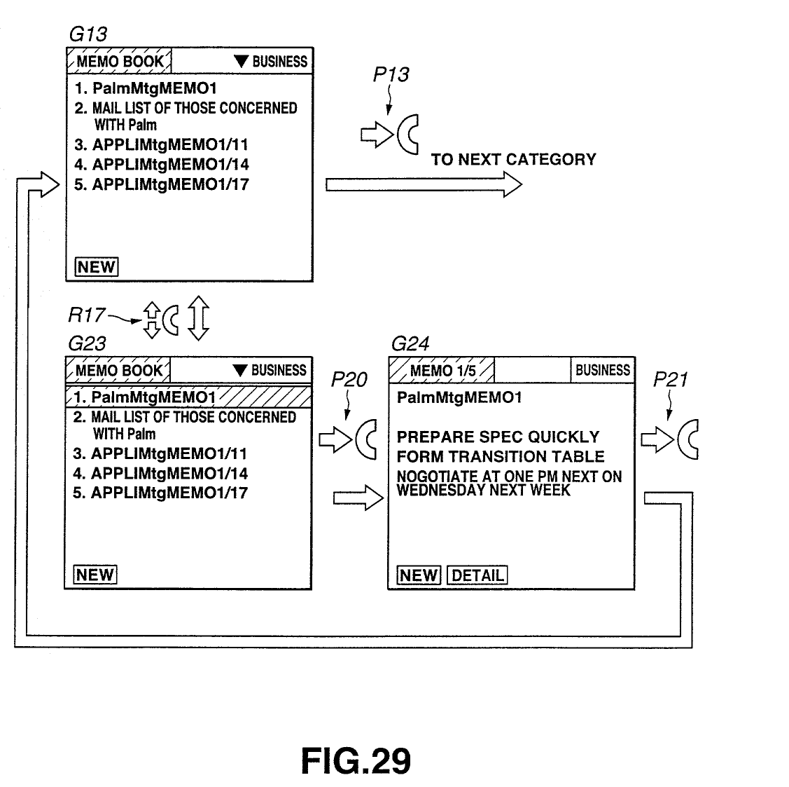

FIG. 29 shows a typical display transition when the information category display of picture G13 of FIG. 24 is made. If, in FIG. 29, as the picture G12 is demonstrated, the dial portion 27 is rotated (R17), the highlighted display of the information item list is changed, as shown in the picture 23. If further the push operation P20 is made, the memo contents associated with the highlighted list item are demonstrated (G24). If, in the state of the picture G24, the dial portion 27 is pushed (P21), the contents of the previous display (G13) are demonstrated.

In the present information processing apparatus 50, described above, different operating possibilities may be represented by the same operation of pushing the dial portion 27 of the jog dial 4 as a given application is running. That is, if a pushing operation is made in the absence of a list item shown highlighted in the aforementioned information item list, that is in the non-selected state of the information item list, the information categories are changed, that is the object being operated is switched. If a pushing operation is done in the presence of the list items shown highlighted in the information item list, that is in the selected state of the information item list, the contents of the information associated with the list item shown highlighted, that is the contents of the application, are displayed, whereas, if the pushing and rotating operations are performed in the absence of the list item among the information list items that is shown highlighted, the picture displayed is scrolled by way of page feed.

That is, in the present information processing apparatus 50, plural operating possibilities can be allocated to a sole operation of the jog dial 4 to enlarge the scope of operation with the jog dial 4, whilst the user may be instantly apprized of the apparatus being in the jog dial operating mode.

Meanwhile, if, in the sequence of processing operations responsive to the operations of the jog dial 4, a touch detection signal of the touch panel 54 is routed to the CPU 70, it is of course possible to execute the processing in meeting with the touch detection signal. In the present information processing apparatus 50, the processing mode responsive to the operation by the touch panel 54 can co-exist with that responsive to the operation by the jog dial 4.

The above-described sequence of processing operations can be performed on the hardware or on the software. If the sequence of the operations is executed on the software, the program making up the software is installed on a computer built in a dedicated hardware or in a general-purpose computer.

A recording medium having recorded thereon a program for executing the above-described sequence of operations, and which is used for installing the program on an information processing apparatus for enabling the apparatus to execute the program, is hereinafter explained.

That is, the program for executing the above-described sequence of operations can be previously recorded on a hard disc or a semiconductor memory, as a recording medium enclosed in e.g., a personal computer, whereby the program can be installed from this personal computer to the information processing apparatus through the aforementioned USB interface 89. The program can also be transiently or permanently stored, that is recorded, on a recording medium, such as a floppy disc, CD-ROM (Compact Disc Read-Only Memory), MO (Magneto-Optical) disc, a DVD (Digital Versatile Disc), magnetic disc or the aforementioned external memory medium 143, in which case the program read out therefrom may be installed on the information processing apparatus through IR communication, USB cable or a cradle device.

Meanwhile, the program can be installed from the aforementioned recording medium through the computer or transferred over radio route through an artificial satellite for digital satellite broadcasting, or transferred over a wired path through LAN (Local Area Network) or over a network, such as Internet, to install the program in e.g., a flash ROM 84 enclosed in the information processing apparatus.

In the present specification, there is no particular necessity of chronologically processing the steps stating the program for performing various processing operations in accordance with the sequence stated in a flowchart, but the respective steps may also be executed in parallel or on the object-by-object basis.

What is claimed is:

1. An information processing apparatus having an operator for generating a signal responsive to at least rotation and pressing thereof, comprising:
storage means for storing a plurality of icons classified in a relevant category from at least two categories; and
control means for switching between a first operating mode displaying a list of said plural icons and a second operating mode for displaying only icons classified in a pre-set one of said plural categories responsive to an operation on said operator.

2. The information processing apparatus according to claim 1 wherein said control means switches from said first operating mode to said second operating mode on detection of the pushing operation of said operator.

3. The information processing apparatus according to claim 2 wherein said control means switches from said second operating mode to said first operating mode on detection of a pushing operation of said operator.

4. The information processing apparatus according to claim 2 wherein said control means includes a third operating mode displaying only the icons classified in a category other than the category associated with said second operating mode, said control means switching from said second operating mode to said third operating mode on detection of the pushing operation of said operator.

5. The information processing apparatus according to claim 4 wherein said control means switches from said third operating mode to said first operating mode on detection of the pushing operation of said operator.

6. An information processing apparatus having an operator for generating a signal responsive to at least rotation and pressing thereof, comprising:
storage means for storing a plurality of files classified in a relevant category among at least two categories set for a pre-set application; and
control means for switching between a first operating mode displaying a list of said plural files and a second operating mode for displaying only files classified in a pre-set one of said plural categories responsive to an operation on said operator.

7. The information processing apparatus according to claim 6 wherein said control means switches from said first operating mode to said second operating mode on detection of the pushing operation of said operator.

8. The information processing apparatus according to claim 6 wherein said storage means stores a plurality of folders classified in a relevant one of at least two categories set for a pre-set application; and wherein said control means switches between a first operating mode displaying a list of said plural folders and a second operating mode for displaying only folders classified in a pre-set one of said plural categories responsive to an operation on said operator.

9. The information processing apparatus according to claim 7 wherein said control means performs switching so as to display a file selected responsive to a rotating operation of an operator in a highlighted fashion and so as to display the contents of the file shown in the highlighted fashion on detection of a pushing operation on said operator.

10. An information processing method for executing information processing responsive to an operating signal generated by an operator responsive to at least rotation and pressing thereof, comprising:
a storage function of storing a plurality of icons classified in a relevant category from at least two categories; and
a control function of switching between a first operating mode displaying a list of said plural icons and a second operating mode for displaying only icons classified in a pre-set one of said plural categories responsive to an operation on said operator.

11. The information processing method according to claim 10 wherein said control function switches from said first operating mode to said second operating mode on detection of the pushing operation of said operator.

12. The information processing method according to claim 11 wherein said control function switches from said second operating mode to said first operating mode on detection of the pushing operation of said operator.

13. The information processing method according to claim 10 wherein said control function includes a third operating mode displaying only the icons classified in a category other than the category associated with said second operating mode, said control function switching from said second operating mode to said third operating mode on detection of the pushing operation of said operator.

14. The information processing method according to claim 13 wherein said control function switches from said third operating mode to said first operating mode on detection of the pushing operation of said operator.

15. An information processing method for performing information processing responsive to an operating signal generated by an operator responsive to at least rotation and pressing thereof, comprising:
a storage function for storing a plurality of files classified in a relevant category among at least two categories set for a pre-set application; and
a control function for switching between a first operating mode displaying a list of said plural files and a second operating mode for displaying only files classified in a pre-set one of said plural categories responsive to an operation on said operator.

16. The information processing method according to claim 15 wherein said control function switches from said first operating mode to said second operating mode on detection of the pushing operation of said operator.

17. The information processing method according to claim 15 wherein said storage function stores a plurality of folders classified in a relevant category among at least two categories set for a pre-set application; and
wherein said control function switches between a first operating mode displaying a list of said plural folders and a second operating mode for displaying only folders classified in a pre-set one of said plural categories responsive to an operation on said operator.

18. The information processing method according to claim 16 wherein said control function performs switching so as to display a file selected responsive to a rotating operation of an operator in a highlighted fashion and so as to display the contents of the file shown in the highlighted fashion on detection of a pushing operation on said operator.

19. A storage medium for storing a program for executing information processing responsive to an operating signal generated by an operator responsive to at least rotation and pressing thereof,
said program including a control processing step for switching between a first operating mode displaying a list of a plurality of icons classified in an associated one of at least two categories and a second operating mode for displaying only icons classified in a pre-set one of said plural categories responsive to an operation on said operator.

20. The storage medium for storing a program according to claim 19 wherein said control processing step switches from said first operating mode to said second operating mode on detection of the pushing operation of said operator.

21. A storage medium for storing a program for executing information processing responsive to an operating signal generated by an operator responsive to at least rotation and pressing thereof,
said program including a control processing step for switching between a first operating mode displaying a list of said plural files classified in a relevant category among said categories and a second operating mode for displaying only files classified in a pre-set one of said plural categories responsive to an operation on said operator.

22. The storage medium for storing a program according to claim 21 wherein said control processing step switches from said first operating mode to said second operating mode on detection of a pushing operation on said operator.

23. The storage medium for storing a program according to claim 21 wherein said control processing step switches between a first operating mode of displaying a list of a plurality of folders classified in a relevant one of at least two categories set for a preset application and a second operating mode displaying only folders classified in a preset one of the two or more categories responsive to an operation on said operator.

24. The storage medium for storing a program according to claim 22 wherein said control processing step for switching so as to display a file selected responsive to a rotating operation of said operator in a highlighted fashion and so as to display the contents of the file shown in the highlighted fashion on detection of a pushing operation on said operator.
